(19) United States
(12) Patent Application Publication
(10) Pub. No.: US 2012/0315839 A1
(43) Pub. Date: Dec. 13, 2012

(54) ANALYZING AUDIENCES AT PUBLIC VENUES

(75) Inventors: Michael Mumcuoglu, Jerusalem (IL); Giora Engel, Mevasseret-Zion (IL)

(73) Assignee: METERLIVE LTD., Modi'in (IL)

(21) Appl. No.: 13/513,604

(22) PCT Filed: Dec. 29, 2010
(86) PCT No.: PCT/IB10/56105

§ 371 Date: Jun. 4, 2012

Related U.S. Application Data
(60) Provisional application No. 61/291,170, filed on Dec. 30, 2009.

(51) Int. Cl. H04H 60/33; H04W 24/00

(52) U.S. Cl. 455/2.01

(57) ABSTRACT

A method for monitoring an audience, includes receiving transmissions over the air, in accordance with a standard communication protocol, from one or more wireless communication devices (24) belonging to members (26) of the audience at a location. The transmissions are analyzed in order to derive a characteristic of the audience.

### CROSS-REFERENCE TO RELATED APPLICATION

This application claims the benefit of U.S. Provisional Patent Application 61/291,170, filed Dec. 30, 2009, which is incorporated herein by reference.

### FIELD OF THE INVENTION

The present invention relates generally to systems and methods for analyzing presence and motion of people, specifically by detection and monitoring of wireless devices in their possession.

### BACKGROUND OF THE INVENTION

Advertisers commonly seek to measure audience response to media that they present. In some settings, such as Web browsing and television viewing, it is possible to monitor audience response interactively. In public venues, however, such information is generally more difficult to collect.

Various solutions to this problem have been proposed in the patent literature. For example, PCT International Publication WO 2008/149368, whose disclosure is incorporated herein by reference, describes a method and system for controlling the display of a set of multiple messages on a display screen in order to optimize the number of qualified viewers exposed to at least a subset of the messages. The system makes use of a method for determining attention metrics of human objects towards a display that is described in PCT International Publication WO 2008/132471, whose disclosure is also incorporated herein by reference. The method comprises acquiring and processing image data to detect presence of the human objects and determine attention metrics such as face towards the display and eyes on the display.

Signals from cellular telephones may be used in tracking people. For example, U.S. Patent Application Publication 2008/0318591, whose disclosure is incorporated herein by reference, describes a system that records the movement of people carrying mobile devices within a specific area using receivers distributed throughout the area. Mobile devices are identified, by way of a unique identifier transmitted on a control channel or the like. Whenever such wireless communication is detected, the direction from which the signal is received is detected. The position of the mobile device (and hence the person carrying it) may be calculated by triangulating results from two or more receiving devices.

### SUMMARY

Embodiments of the present invention that are described hereinbelow provide systems, apparatus and methods for monitoring the audience at a given location. Although the term “audience” is used generally (and also in some of the embodiments described below) to refer to a group of people assembled to see and/or hear some presentation, the term should be understood more broadly in the context of the present patent application and in the claims to mean any group of people who are present at a given time in a given location. “Monitoring” in this context may refer to any observable characteristic of the audience or of individual members of the audience, such as the number of members of the audience, their personal characteristics, behavior, or possessions, or any combination of such qualities.

There is therefore provided, in accordance with an embodiment of the present invention, a method for monitoring an audience, which includes initiating a connection with wireless communication devices at a location, in accordance with a standard communication protocol, by transmitting a signal over the air at the location. Transmissions are received in response to the signal over the air from one or more of the wireless communication devices belonging to members of the audience at the location. Alternatively or additionally, the received transmissions are broadcast over the air, in accordance with a standard communication protocol, by one or more wireless communication devices belonging to members of the audience at a location. The transmissions are analyzed in order to derive a characteristic of the audience.

Typically, the signal and the responses are transmitted over an Industrial, Scientific and Medical (ISM) radio band, and the protocol is selected from a group of protocols consisting of Personal Area Network (PAN) and Wireless Local Area Network (WLAN) protocols.

The method may optionally include receiving cellular transmissions made over a cellular network by one or more mobile devices belonging to the members of the audience, and analyzing the cellular transmissions in order to derive the characteristic of the audience.

In one embodiment, analyzing the transmissions includes counting a number of the wireless communication devices operating at the location.

In another embodiment, multiple, successive transmissions are received from at least one of the wireless communication devices, and a dwell time of the at least one of the wireless communication devices in the location is estimated responsively to the multiple, successive transmissions.

In some embodiments, the transmissions are analyzed to estimate respective distances of the wireless communication devices from a receiver that receives the responses. The transmissions may be analyzed to detect motion of one or more of the members of the audience using multiple estimates of the respective distances over time and to estimate a velocity of the motion based on the multiple estimates.

In some embodiments, the transmissions are received at multiple different locations, and analyzing the transmissions includes detecting a presence of at least one of the wireless communication devices at two or more of the locations at different, respective times. Analyzing the transmissions may include tracking a pattern of behavior of at least one of the members of the audience to whom the at least one of the wireless communication devices belongs responsively to the detected presence.

Additionally or alternatively, analyzing the transmissions includes extracting identifiers of the wireless communication devices from the transmissions and cross-referencing the identifiers with other identifying information regarding the members of the audience. Cross-referencing the identifiers may include creating an association between at least two co-occurring identifiers.

There is also provided, in accordance with an embodiment of the present invention, a method for monitoring an audience, including receiving signals that are transmitted over the air, in accordance with a standard communication protocol, by one or more wireless communication devices belonging to members of the audience. The transmissions are processed in order to discover identifiers of the wireless communication devices, and the identifiers are analyzed in order to extract demographic information with regard to the members of the audience.

In a disclosed embodiment, analyzing the identifiers includes processing device names transmitted by the wireless communication devices in order to extract the demographic information.

Typically, the demographic information includes at least one item of data with respect to a member of the audience, selected from a group of items consisting of a name, an age, a gender, and an ethnic group of the member.

There is additionally provided, in accordance with an embodiment of the present invention, apparatus for monitoring an audience, including a transceiver, which is configured to be deployed at a location and to transmit a signal over the air at the location so as to initiate a connection with wireless communication devices at a location, in accordance with a standard communication protocol, and to receive transmissions in response to the signal over the air from one or more of the wireless communication devices belonging to members of the audience at the location. Additionally or alternatively, the transceiver is configured to be deployed at a location and to receive transmissions that are broadcast over the air, in accordance with a standard communication protocol, by one or more wireless communication devices. A processing unit is configured to analyze the transmissions in order to derive data indicative of a characteristic of the audience.

There is further provided, in accordance with an embodiment of the present invention, apparatus for monitoring an audience, including a transceiver, which is configured to receive signals that are transmitted over the air, in accordance with a standard communication protocol, by one or more wireless communication devices belonging to members of the audience. One or more processors are configured to process the transmissions in order to discover identifiers of the wireless communication devices, and to analyze the identifiers in order to extract demographic information with regard to the members of the audience.

The present invention will be more fully understood from the following detailed description of the embodiments thereof, taken together with the drawings in which:

### BRIEF DESCRIPTION OF THE DRAWINGS

FIG. 1 is a schematic, pictorial illustration showing a system for monitoring audiences, in accordance with an embodiment of the present invention;

FIG. 2 is a block diagram that schematically illustrates an audience sensor, in accordance with an embodiment of the present invention;

FIG. 3 is a flow chart that schematically illustrates a method for monitoring an audience, in accordance with an embodiment of the present invention;

FIG. 4 is a flow chart that schematically illustrates a method for extracting demographic information from wireless communications, in accordance with an embodiment of the present invention; and

FIG. 5 is a flow chart that schematically illustrates a method for extracting behavioral information from wireless communications, in accordance with an embodiment of the present invention.

### DETAILED DESCRIPTION OF EMBODIMENTS

### Overview

On-line advertisers are able to get an indication of the exposure and effectiveness of their advertising by monitoring “impressions” and “clicks” when Web pages containing their advertisements are presented. Mobile audiences in public venues are much more difficult to monitor, since there is generally no simple and accessible indication of the number of people present in a given venue over time or of how long each person spends there. Cellular telephone networks are able to glean information regarding the locations of their subscribers, but precise location data regarding any given telephone can generally be extracted only during actual calls, and the availability of this sort of data to advertisers and other third parties is typically limited for legal and commercial reasons.

Embodiments of the present invention that are described hereinbelow provide apparatus and methods that enable more accurate and richer monitoring of audiences, using the wireless communication devices that are carried by members of the audiences. These devices often have not only a cellular radio and communication interface, but also radios and interfaces for communication over local, short-range networks, such as Wireless Local Area Networks (WLANs) and Personal Area Networks (PANs), which are typically active whenever the wireless communication device is powered on. These local networks, which commonly operate in unlicensed Industrial, Scientific and Medical (ISM) bands, can generally be used and sampled freely by any interested party and provide rich information regarding the communication devices that use them. The embodiments disclosed below take advantage of these properties.

In the disclosed embodiments, a sensor for monitoring an audience comprises one or more transceivers, which receive signals over the air from wireless communication devices carried by members of the audience at a given location. The transceivers may actively communicate with the wireless communication devices, or they may, alternatively or additionally, passively receive signals from the devices. A processing unit analyzes the signals from the devices in order to derive audience characteristics.

In some embodiments, each transceiver transmits signals over the air to the wireless communication devices in its vicinity in order to initiate communications with the devices. (As noted above, certain transceivers may also passively listen to communications that are transmitted over the air.) The signals transmitted by the transceiver comply with a standard communication protocol, such as Bluetooth (a PAN protocol) or IEEE 802.11(a WLAN protocol), which is expected to be supported by many of the wireless communication devices in the vicinity. The transmitted signals cause wireless communication devices to return a standard response, often automatically, without involvement of the user. The transceiver passes these responses to the processing unit for analysis.

The processing unit may use the communications received by the transceivers in a wide variety of ways. For example, it may count the number of wireless communication devices operating at the location of the sensor in order to assess audience size. It may also analyze the signal strengths in order to estimate the respective distances of the devices from the sensor. Additionally or alternatively, the processing unit may analyze successive transmissions of a given wireless communication device in order to estimate the dwell time of the device at the location of the sensor and/or the velocity (speed and direction) of motion of the device toward or away from the sensor.

Further additionally or alternatively, the processing unit may extract demographic information from the responses with regard to the members of the audience. For example, in some communication standards, such as Bluetooth, the wireless devices may identify themselves by name in their responses, wherein the “name” parameter is often set to the user's name or to a user-selected name. The processing unit may receive and analyze these identifiers for demographic information, such as name, age, gender, and/or ethnic group of the member.

In some embodiments, sensors of this sort are deployed at multiple different locations, and a data center collects and compares the information provided by multiple sensors. For example, when the data center receives information from two (or more) of the sensors indicating that a given device was detected at the sensor locations at different, respective times, it can use this information to track the pattern of behavior of the user of the device, as well as assessing demographics, fields of interest, and other factors. This pattern can be used, for instance, to measure effectiveness of advertising by correlating the presence of a user at a promotional location where a product was promoted with later presence of the same user at another location where the product is sold. Additionally or alternatively, different wireless device identifiers may be cross-referenced in order to find associations between co-occurring identifiers, and wireless device identifiers may be cross-referenced with information from external data sources.

### System Description

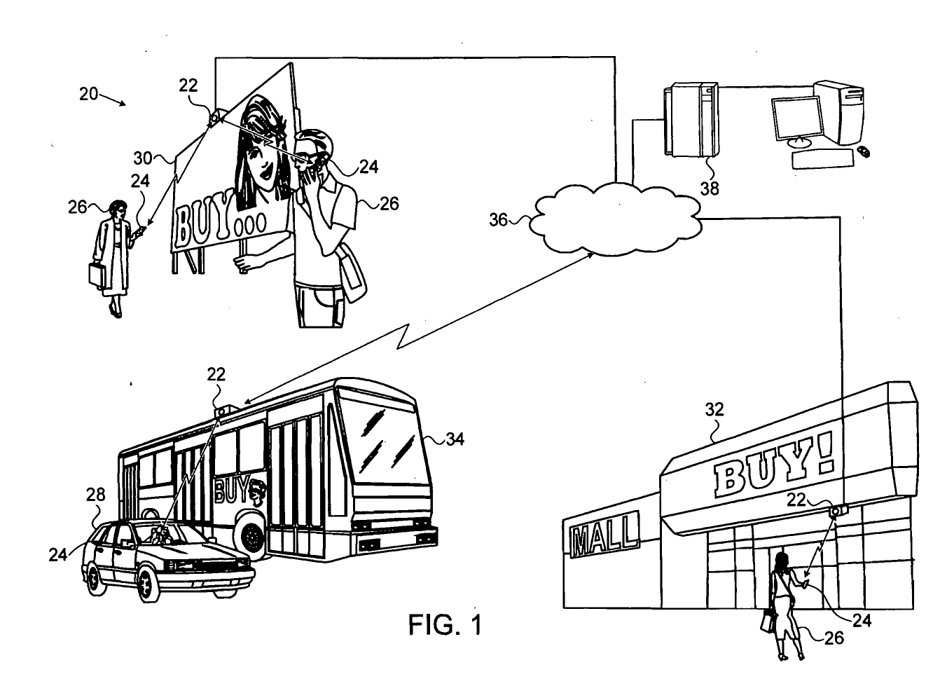

FIG. 1 is a schematic, pictorial illustration showing a system 20 for monitoring audiences, in accordance with an embodiment of the present invention. As noted earlier, the term “audience” is used broadly in this application to refer to the people who are present at some location. In the embodiment pictured in FIG. 1 and in the embodiments described below, the audience will be assumed, for the sake of illustration, to be a commercial audience, located in proximity to promotional content in a public venue. More generally, however, the “audience” of interest may comprise people in substantially any location, whose presence and behavior is monitored for substantially any purpose, including (but not limited to) commercial, planning, research, or security purposes.

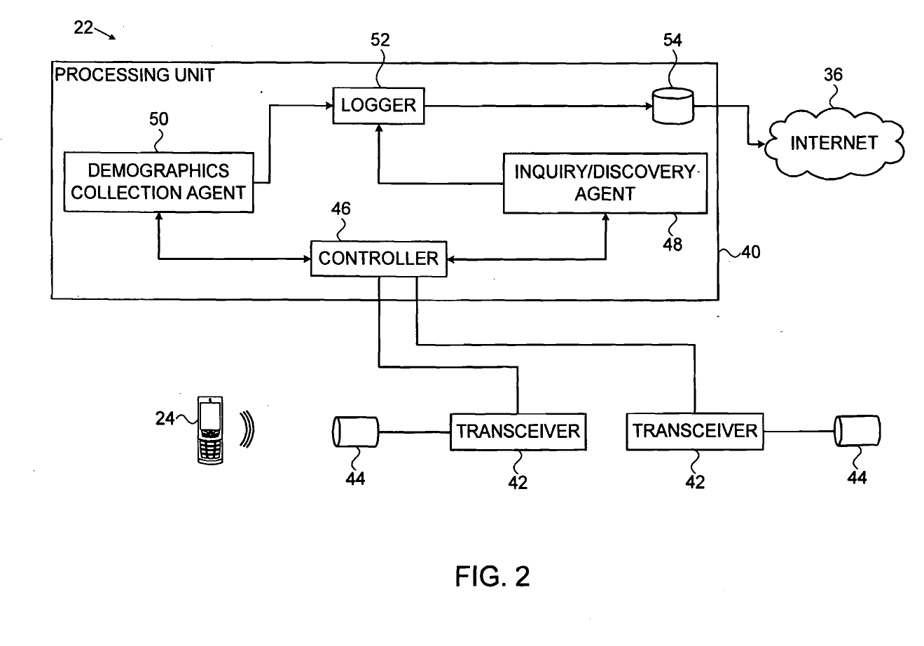

System 20 comprises sensors 22, which are described in detail below with reference to FIG. 2. The sensors communicate with and receive transmissions from wireless communication devices 24 that are carried by users 26 who are members of the audience at each sensor location. Devices 24 may comprise substantially any type of communication unit with a suitable wireless interface, such as cellular telephones, personal digital assistants and portable computers, for example. The audience members whose devices 24 are detected and monitored by sensors 22 may be stationary or mobile, either on foot or in a vehicle 28.

Sensors 22 may be deployed in both outdoor and indoor locations and on mobile, as well as stationary, platforms. Thus, in the pictured embodiment, sensors are deployed, for example, on or near a billboard 30, in a shopping mall 32 or store, or on a bus 34.

Sensors 22 that are mounted on mobile platforms, such as bus 34, may include a location detector, such as a Global Positioning System (GPS) unit, to add a location tag to audience measurements. Such sensors may thus gather audience presence and demographic information over wide areas and may associate each detected device 24 with a particular residential, work or commercial location. Alternatively or additionally sensors mounted on a mobile platform such as bus 34 can be used to measure exposure of audiences (both inside and outside the platform) to advertising that is displayed on the platform.

Typically, sensors 22 communicate over a network 36, such as a private network and/or the Internet, with a data center 38. Sensors 22 may be connected to network 36 via either wired or wireless link, as are known in the art. The data center processes information provided by the sensors in order to find correlations and generate reports, and it may also download program and configuration instructions to the sensors. The reports may include audience segmentation according to demographic and temporal factors. The data center may also use geographical information about the sensors (such as their location coordinates or street locations) to generate global reports concerning audience presence and movement over large areas, including interpolation of data between the sensor locations. Additionally or alternatively, data center 38 may make certain statistical information available via a Web interface, to indicate, for example, the amount of crowding and congestion has been detected or is likely to occur in a given public venue.

Alternatively, sensors 22 may operate independently and autonomously, without a network link. In this case, data stored by a sensor may be collected intermittently by connecting a suitable data recorder to the sensor (via wired or wireless communication), for example.

FIG. 2 is a block diagram that schematically shows details of sensor 22, in accordance with an embodiment of the present invention. Sensor 22 comprises a processing unit 40 and one or more transceivers 42. Each transceiver is connected to a corresponding antenna 44, or to multiple antennas if appropriate, and is configured to communicate with wireless communication devices 24 in accordance with a standard protocol. The antennas may be stationary, with a fixed field of view (directional or omnidirectional), or they may alternatively be rotatable or otherwise movable to vary their fields of view continually or on command. Each transceiver 42 typically comprises a physical layer (PHY) radio interface and a medium access control (MAC) processor (not shown in the figures) as are known in the art. Other elements of sensor 22 that will be apparent to those skilled in the art, such as a power supply with lines connection, battery, or solar power input, are likewise omitted from the figure for the sake of simplicity.

Processing unit 40, transceiver(s) 42 and antenna(s) 44 may be contained together in an integral case. Alternatively, the transceiver(s) may be deployed remotely from the processing unit and connected by wired or wireless links, possibly with multiple transceivers in different locations. Further alternatively or additionally, the processing unit and transceiver may be contained together in a sheltered unit, which is connected by a cable to an outdoor antenna. For example, the processing unit and transceiver may be contained inside billboard 30 and connected to the power and possibly communication infrastructure of the billboard, while the antenna is mounted on top of or beside the billboard so that its field of view contains people who can see the billboard.

Each transceiver 42 operates in accordance with one or more standard protocols, typically PAN or WLAN protocols. Such protocols commonly operate in ISM bands, such as the 2.45 GHz band, and are designed for short-range operation, typically over a radius of 100-200 m or less (although suitably-designed transceivers may be able to detect such signals over larger ranges. Example implementations of certain features of sensor 22 will be described hereinbelow with reference to the Bluetooth and IEEE 802.11 protocols, which are the most commonly-used PAN and WLAN protocols, respectively. Transceivers 42 may alternatively be configured for any other suitable protocol, such as ZigBee, HiperLAN, NFC, or other protocols that are known in the art.

In some embodiments, transceivers 42 (operate by transmitting signals, in accordance with the appropriate protocol, that cause devices 24 to transmit responses. The transceiver then receives and processes these responses, as described below.

Additionally or alternatively, one or more of the transceivers that are associated with a given sensor may be configured to receive signals that devices 24 transmit independently of the transceiver. (In such embodiments, the transceiver may consist of a receiver only, without a transmit function.) These signals may be received over various networks, such as WLAN, PAN or cellular networks, for example GSM or CDMA. Such communications may be directed to a specific base station or access point or to another wireless device. Alternatively, the signals received by the transceivers may be broadcast messages that are not directed to any specific endpoint or base station (such as the type of broadcast probe requests transmitted by a WLAN device in search of access points). In the case of cellular communications, for legal reasons, transceivers 42 are not generally permitted to transmit cellular signals to wireless devices (other than to the base stations of the cellular network), but they may be able to intercept and use the cellular transmissions of devices 24 for purposes of audience monitoring.

Although sensor 22 may comprise only a single transceiver 42, multiple transceivers are advantageous in expanding the range of coverage and the number of devices 24 that the sensor can monitor concurrently. Different transceivers in the same location may be used to monitor different wireless networks (such as PAN, WLAN or cellular) and different communication standards simultaneously. Alternatively or additionally, multiple transceivers operating on the same standard can also enhance the performance of the sensor. The Bluetooth protocol specification, for example, defines the frequency scanning process during an “inquiry” (transmission of signals from transceiver 42 to devices 24) that limits the device detection rate and the response rate from each device. Performing multiple inquires using multiple transceivers enables sensor 22 to scan multiple frequencies at the same time and thus to reduce the detection time while increasing the detection probability and the response rate. Furthermore, multiple transceivers are useful in cases in which a large area is to be covered, or when positional or directional classification of the audience is desired.

Deployment of multiple transceivers in mutual proximity, however, may give rise to problems of interference. (Such interference may also occur among multiple sensors, each with its own transceiver or transceivers, in mutual proximity.) To minimize these problems, sensor 22 may apply a synchronization strategy, for example:
Random Strategy—After an inquiry is complete, each transceiver waits for a uniformly distributed random back-off time. This back-off ensures that any pair of inquiring transceivers will not be constantly synchronized, transmitting and scanning the same frequencies.
Fixed Strategy—Inquiries are performed at fixed offsets so that the chances of two or more transceivers transmitting and scanning the same frequency are minimized. Synchronization is achieved by management of both transceivers by the same processing unit, or by time synchronization between two or more sensors.

As explained below, processing unit 40 may instruct transceivers 42 to query detected devices 24 for additional information (such as device name, services, etc.) Such querying, however, interrupts the inquiry process and may therefore degrade the performance of sensor 22 in detecting additional wireless communication devices. Furthermore, these queries may fail if the queried device is not within range of the querying transceiver. To maximize the probability of success and to balance the load of these queries, processing unit 40 may distribute the queries among the transceivers. The balancing strategy may take into account the following factors, inter alia:
The number of queries performed by each transceiver over the past time period (for example, a certain number, X, of seconds) and the numbers of successful and failed queries.
The most probable position of the detected device when the query is to be performed.
The number of devices detected by each transceiver in the past Y seconds.
The range of each transceiver.
Whether the device was previously queried by any other transceiver and whether it was queried successfully.

Processing unit 40 typically comprises one or more microprocessors with suitable interfaces and memory. The microprocessors are programmed in software to carry out the functions that are described herein. This software may be downloaded to the processing unit in electronic form, over a network, for example. Alternatively or additionally, the software may be stored on tangible storage media, such as optical, magnetic, or electronic memory media.

Further alternatively or additionally, at least some of the functions of processing unit 40 may be carried out by hard-wired or programmable digital logic circuits. Although processing unit 40 is shown in FIG. 2 as comprising certain functional blocks, in actual implementation a number of the functions (or all of the functions) of these blocks may be carried out by the same processor, or a given function may be distributed among multiple components.

Processing unit 40 comprises a controller 46, which controls transceivers 42 (including the coordination functions mentioned above) and collects the responses received by the transceivers from wireless communication devices 24. Controller 46 passes the response information to an inquiry/discovery agent 48, which is responsible for functions such as counting the audience and collecting measures of the dwell time and motion of members of the audience. In addition, a demographics collection agent 50 extracts response information of relevance to audience demographics. A logger 52 records data collected by agents 48 and 50 in a memory 54. The information in memory 54 may be periodically reported to data center 38 via network 36.

The functions of agents 48 and 50 are described in detail in the next section. These functions are assumed in the description below to include analysis of inquiry/discovery and response data to extract actual dwell, motion, and demographic information. Alternatively, the data collected by agents 48 and 50 may be transferred in raw form to data center 38 for performance of such analyses. Although the description may refer, for the sake of simplicity, to performance of specific analysis functions in either locally in the processing unit or centrally in the data center, it should be understood that these functions may generally be implemented either locally or centrally, and all such alternative implementations are within the scope of the present invention.

In addition to generating reports to users, either data center 38 or processing unit 40 (or both) may actively make decisions based on audience analysis. For example, a sensor 22 that is associated with an electronic billboard may vary the advertising content that is displayed based on characteristics of the audience, such as the age of one or more members of the audience that is inferred from responses received from wireless communication devices (as explained below). Alternatively or additionally, the sensor may cause the billboard to power down, by reducing its lighting intensity, for example, when it detects that there is little or no audience present. Sensors may also be configured to push advertisements to certain wireless communication devices in their proximity.

Still another possible function of sensors 22 and/or data center 38 is impression-based sale of advertising media. In this sort of scheme, an advertiser pays for display of promotional content based on the number of audience members (as detected by the sensor) counted in proximity to the advertisement. The count may be further refined based on demographic information extracted by the sensors or cross-references with external data, as described below.

Advertisers may bid for time slots on a per-impression basis (for example, ten cents per impression). Bids may even be segmented according to demographic factors, dwell time, and/or new vs. repeat viewers. For each time slot, data center 38 may then choose the bid that will give the highest return based on audience information gathered in one or more previous time slots. The data center will then instruct the display (such as billboard 30) to present the corresponding advertising content.

The count numbers generated by system 20 (for impression-based advertising and for other purposes) are typically not precise counts. The reasons for this imprecision are inherent in the method of counting: Not all members of the audience necessarily carry a wireless communication device (while some members may carry more than one device), and some devices may be turned off or otherwise not detectable by sensors 22. Therefore, data center 38 is in most cases capable of providing only estimated counts. These estimates may be calibrated, for example, by independently counting the size of the audience at a location or at certain types of locations and comparing this independent count to the counts generated by sensors 22 at the same location or locations. Data center 38 may apply the calibration factors thus derived in adjusting the counts of wireless communication devices that it receives from sensors 22.

In an alternative embodiment (not shown in the figures), wireless communication devices used by certain individuals may themselves be configured to serve as mobile short-range sensors in order to extend the coverage of system 20. The system operator may offer inducements to such individuals to install the necessary monitoring software on their personal mobile phones, for example. The software can use the existing hardware of the mobile phone to detect and monitor other devices and to transfer the results to data center 38, along with a location tag indicating where the measurements were made. Possible functions of this software may include:
1. Scanning for nearby Bluetooth devices using the internal Bluetooth transceiver, in a manner similar to the methods performed by sensors 22, as described below. To avoid draining the battery, the frequency of the scans can be decreased and adapted to the environment.
2. Detecting WLAN devices in the area in a similar manner.
3. Listening to surrounding sounds using the microphone of the mobile phone, to detect how much noise there is in the environment and the nature of the sounds.
4. Estimating the number of people in the area using the cellular capabilities of the phone to detect, for example, how busy the network is.
   The above functions of estimating audience characteristics based on surrounding sounds and network load may also be implemented by dedicated sensors 22.

People wishing to gain information regarding specific locations can do so via a Web browser or using the monitoring application that is installed on their cell phone. The information may include current audience counts and possibly demographics of the audience in monitored locations. The monitoring information may be gathered both from mobile phone sensors, as described above, and from other sensor installation (billboards, public transportation, etc.) For example, a user could query for occupancy and popularity of certain places (such as a café) and receive information about their current status, if available, or estimates based on historical measurements made at similar times on previous days.

### Methods for Audience Data Extraction

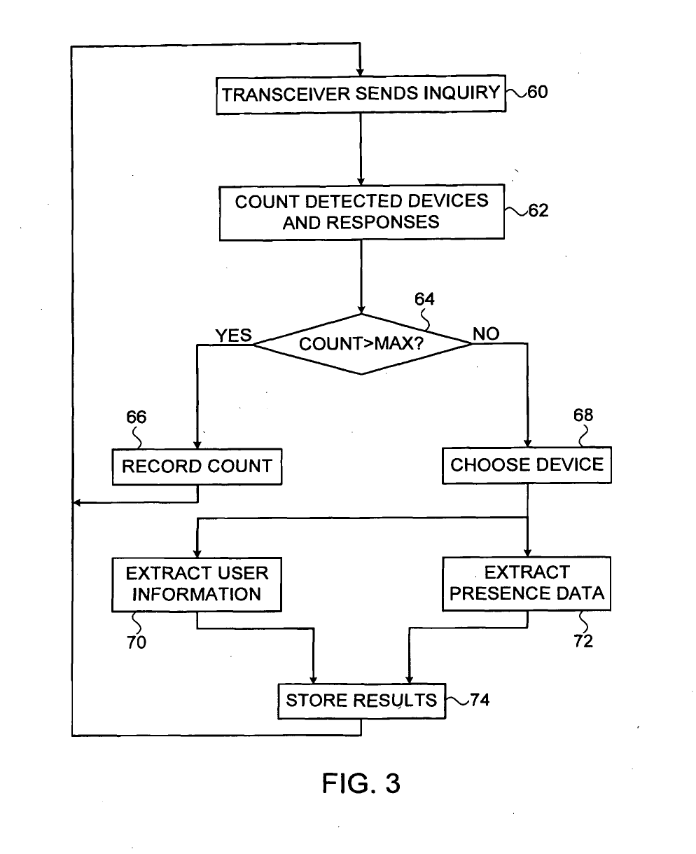

FIG. 3 is a flow chart that schematically illustrates a method for monitoring an audience, in accordance with an embodiment of the present invention. The method is described hereinbelow, for the sake of clarity, with reference to the elements of system 20 and sensor 22 that are shown in FIGS. 1 and 2 and described above. Alternatively, the principles of this method, as well as the methods shown in the figures that follow, may be implemented in other transceiving and processing environments, as will be apparent to those skilled in the art. All such alternative implementations are considered to be within the scope of the present invention. Although the specific method described below is based on active initiation of communications by transceivers 42, sensors 22 may also passively detect signals transmitted by wireless communication devices 24, as explained above.

Each transceiver 42 periodically transmits inquiry signals, at an inquiry step 50. The nature of the inquiry signal depends on the protocol under which the transceiver is programmed to operate.

In the Bluetooth protocol, for example, the inquiry signal is referred to as an “Inquiry” and causes active Bluetooth-enabled wireless communication devices 24 that are in range to transmit an “Inquiry Response.” A Bluetooth device that is within range of sensor 22 during multiple inquiries may be queried repeatedly. For older Bluetooth devices, the inquiry response contains only the MAC address of the responding device and other low-level parameters. In newer devices (which comply with standards starting from the Bluetooth 2.1 specification), the device may send an “Extended Inquiry Response,” which also contains the device name and capabilities. (The contents of the inquiry response and the manner in which processing unit 40 uses the response information are described further hereinbelow.) Transceiver 42 may be configured to perform a Bluetooth Inquiry with Received Signal Strength Indication (RSSI) (as defined in the Bluetooth 1.2 specification), in which the transceiver registers the RSSI of the received responses.

As another example, in the IEEE 802.11 WLAN protocol, the “inquiry signals” transmitted by transceiver 42 may emulate public wireless hotspots. In this case, the transceiver may, for instance, transmit broadcast frames (“beacons”) announcing the presence of the hotspot. Wireless communication devices 24 are frequently configured to detect and automatically connect to such hotspots or to prompt the user to connect. The transceiver may be assigned a hotspot name (such as “Wireless” or “default”) that will encourage such devices 24 to respond with an association request or other response.

Alternatively, as noted earlier, transceivers 42 may passively detect wireless communication devices 24 by receiving and recording the broadcast signals they transmit as they search for WLAN access points. The methods of detection and analysis that are described here with reference to transceiver-initiated communications may likewise be applied, mutatis mutandis, to passively-received broadcast signals, as well as to other types of PAN, WLAN and cellular communications that may be intercepted by the transceivers.

Transceiver 42 receives responses from devices 24 in its vicinity and counts the number of responses, at a response reception step 62. From each response reported by the transceiver, controller 46 typically extracts and records an identifier, such as the MAC address of the transmitting device, which may be used in identifying subsequent responses from the same device, as well as in querying the device for additional parameters, such as parameters that may be relevant to demographic analysis.

When transceiver 42 detects devices 24 at step 62 without reliance on responses to the inquiry at step 60, sensor 22 may, for example, detect and count Bluetooth inquiries or other “pairing” or connection requests that may be periodically transmitted by devices within its range. It may also detect Bluetooth signals transmitted over existing connections, such as between a cellular telephone and an associated Bluetooth headset. Similarly, the transceiver may intercept WLAN transmissions between devices 24 and a nearby hotspot, as well as broadcasts of devices scanning for access points, exposing ad hoc networks, performing Bluetooth inquiries, etc. (As noted earlier, broadcast communications are not directed at a specific access point or wireless device.) Subject to restrictions of privacy laws, processing unit 40 may also analyze the contents of transmissions between devices 24 and WLAN hotspots, such as Web sites browsed by the device in question, in order to extract demographic information.

Further alternatively, transceiver 42 may detect devices at step 62 based on cellular transmissions by devices 24. Each cellular device transmits signals for various purposes, for example:
Periodic communication with the cellular network, such as location updates.
During a data transfer session, for example, an automatic periodic check for new email message.
During a phone call or while sending/receiving Short Message Service (SMS) messages.
When the device is handed off from one cell to another.
   When transceiver 42 receives cellular transmissions, controller 46 may record the number of transmissions (which is proportional to the number of devices present), as well as identifying information, such as the Temporary Mobile Subscriber Identity (TMSI) that is used in GSM networks or other identifiers of the telephone or the subscriber. It may be possible to cross-reference such identifiers with the cellular provider's database to extract additional demographic information.

Alternatively, transceiver 42 may be configured to serve as or emulate a cellular base station (assuming such operation is legally permissible). The cell thus established may be a part of an existing cellular carrier network, a new carrier network or a nonexistent network. In such embodiments, the transceiver will transmit cellular beacon signals at step 60 and will receive responses from devices 24 at step 62 in accordance with the applicable protocol.

Processing unit 40 counts the number of devices detected in each cycle of operation of sensor 22, in a counting step 64. Using the device identification information that was collected at step 62, processing unit 40 may choose to perform more detailed analysis of audience behavior and demographics. Such analysis, however, uses resources of transceivers 42 and processing unit 40, which may come at the expense of the basic function of assessing audience size. In such cases, to avoid losing count information, the processing unit may compare the device count to a preset threshold level (MAX). If the count is greater than the threshold, logger 52 simply records the responses and data or parameters that were transmitted by the mobile devices in the memory 54, at a count recording step 66, and the sensor returns to step 60.

On the other hand, if conditions permit, processing unit 40 may choose at step 64 to collect further data regarding one or more members of the audience. For this purpose, the processing unit chooses a device 24 (or multiple devices) whose presence in the vicinity was detected at step 62, at a device selection step 68. The device is typically identified by the MAC address and/or other identifying data recorded by controller 46 at step 62. Sensor 22 may query the same device multiple times in order to collect additional information and track the movement and/or dwell time of the user of the device.

Processing unit 40 instructs one of transceivers 42 to communicate with the chosen device 24, typically by transmitting a further query or other message addressed to the device, using the previously-recorded MAC address or other identifier. If sensor 22 includes multiple transceivers, the processing unit may select the transceiver that is in the best position to connect with the device in question (based, for example, on the RSSIs of the signals that were received at step 62). The query may ask the chosen device to report its device name (as provided by the Bluetooth protocol, for example). If the chosen device does not respond to the query within a certain timeout period, typically one or a few seconds, the processing unit may direct the transceiver to query another device.

When transceiver 42 receives a response from the chosen device, controller 46 passes the response information to one or both of inquiry/discovery agent 48 and demographics collection agent 50. Alternatively or additionally, when the transceiver intercepts transmissions from devices 24 that are not in response to queries from sensor 22 (as in the cellular and certain other scenarios described above), the response information may likewise be passed to agents 48 and/or 50.

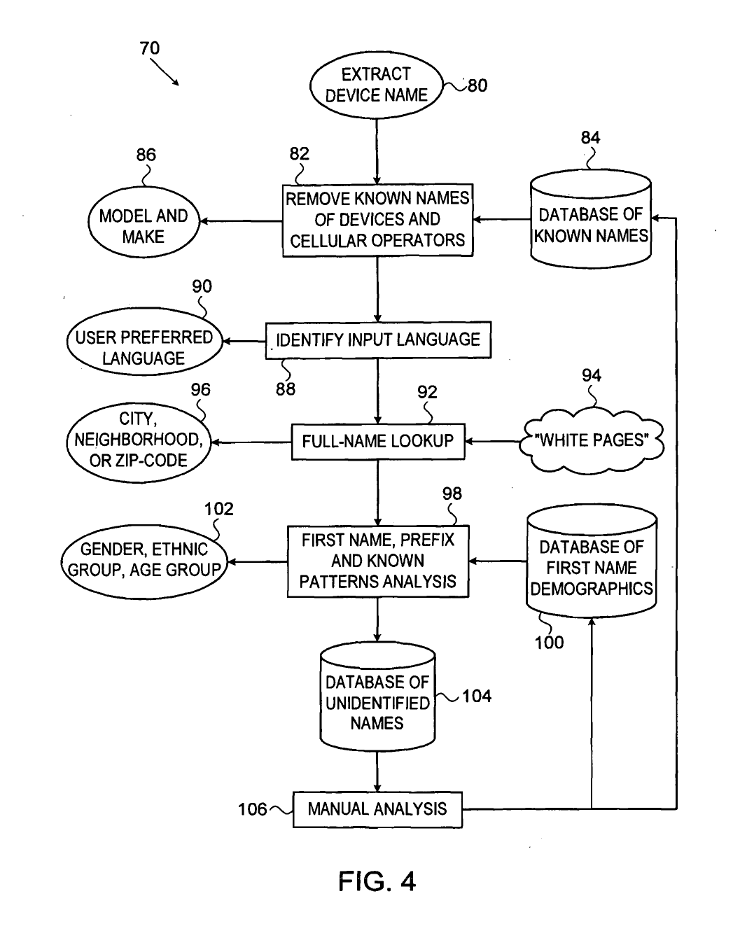

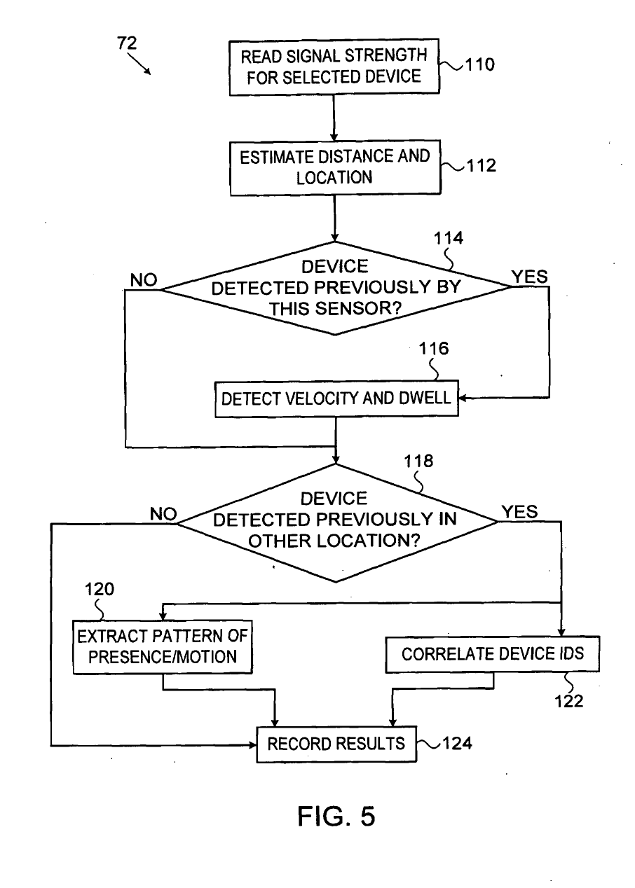

Demographics collection agent 50 extracts demographic information from the responses collected by transceiver 42, at a user information extraction step 70, while inquiry/discovery agent 48 extracts device dwell and motion patterns, at a presence data extraction step 72. Alternatively, the demographics extraction and/or analysis of dwell-time and/or motion patterns be implemented in data center 38 rather than in sensor 22. Example implementations of these steps are described in detail hereinbelow with reference to FIGS. 4 and 5. Logger. 52 stores the results in memory 54, at a data storage step 74. The data that are gathered in this manner may be transmitted to data center 38 and/or may be further processed locally by processing unit 40, as described above.

FIG. 4 is a flow chart that schematically shows details of user information extraction step 70, for extracting demographic information from wireless communications, in accordance with an embodiment of the present invention. Although certain steps in this method are attributed in the description below to demographics collection agent 50, they may alternatively be performed by a computer in data center 38. In this example, it is assumed that transceiver 42 has received a transmission from the chosen device 24 providing a device name 80, which is then extracted and processed by demographics collection agent 50. For instance, name 80 may be a Bluetooth user-friendly device name, which is normally assigned to each device, in addition to the MAC address, in order to enable users to distinguish one Bluetooth device from another.

The Bluetooth specifications do not specify how the device name should be assigned, but in practice it is commonly assigned by one or more of the following processes:
a. A default name may be set by the manufacturer and typically includes the manufacturer's name as well as the model name (such as “Nokia 6267” or “SAMSUNG E250”).
b. Cellular operators who sell devices to subscribers sometimes change the default name, typically leaving the model name and adding their own name (such as “Orange Nokia E71” or “Pelephone KP275”).
c. The operating system of device 24 may automatically assign a new name when the device is configured by the user, such as the user name (such as “Michael's Mac Book Air”).
d. Some devices prompt the user to optionally modify the default device name when Bluetooth is used for the first time. In this case, some users may replace the default name with their own name or append their own name to the default name, while other users may use nicknames, abbreviations, or humorous phrases.
   Transmissions received from Bluetooth devices may also include other information of demographic value, such as the Bluetooth version (which gives an indication of the year of manufacture), device class (smart phone, computer, audio device, etc.), and capabilities, such as supported protocols and services.

Agent 50 processes extracted name 80 through a series of modules to derive technical and demographic information. A device name module 82 compares name 80 to a database 84 of known device and operator names in order to identify and remove known names indicating a model and make 86 and/or cellular operator. The make and model number may give an indication of the product preferences, socio-economic status and possibly the age of the user. (For example, BlackBerry users are more likely to be affluent professionals, while users of advanced smart phones are likely to be technophiles.) It may also be possible to extract make and model information from the MAC address of device 24, since the first three bytes of the MAC address indicate the manufacturer, and manufacturers tend to assign a certain address range to each product model.

A language module 88 identifies the input language of the name (such as English, Chinese or Arabic), thus giving the user's preferred language 90. This information is indicative of the user's ethnicity, and may also relate to socio-economic status.

A full-name lookup module 92 identifies full names or family names appearing in device name 80 and may looks them up in a directory 94. Examples of such directories include “White Pages” telephone directories in the United States, as well as various government and privately-maintained databases. Module 92 may thus find possible addresses 96 of users, including demographic features such as city, neighborhood and postal code of their residences. This sort of address information is useful in promotional campaigns that target certain geographical areas and can also provide indications of ethnicity, socio-economic status and other factors.

A detail processing module 98 extracts and looks up the remaining words in name 80, after product and operator names and possibly surnames have been removed. The details processed by module 98 may include first names, nicknames, prefixes, and other identifiable patterns. Module 98 may look up these details in a database 100 of known first names and prefixes, which associates each name or prefix with demographic characteristics. These associated characteristics may include the gender, ethnicity and age group 102 that are most likely to be associated with a given name or prefix.

Agent 50 stores all remaining unidentified names in a database 104 for further manual analysis 106. A human operator may review the entries in database 104 in order to identify new device names, first names, and common prefixes, and the results of this review are used in updating databases 84 and 100.

Although the above description refers specifically to Bluetooth device names and parameters, similar methods may be applied to parameters gleaned from identifying information in WLAN and cellular transmissions. For example WLAN devices typically search for access points that are recorded in their memory from previous associations. For this purpose, the WLAN devices transmit broadcast messages with the service set identifiers (SSIDs) of these access points. The methods of extracting demographic information from a name that are described above can likewise be applied to the access points names that are transmitted by WLAN devices.

Additionally or alternatively, the data content of transmissions intercepted by transceivers 42 may be processed (to the extent permitted by law) to extract more detailed demographic data. For example, when transceiver 42 intercepts Web communications, agent 50 may infer demographic data based on the URLs and HTTP header information in the transmissions.

The presence of an identified device 24 in the location of a given sensor 22 may itself be indicative of demographic characteristics, particularly when the device is detected repeatedly in the same location. Depending on the sensor location, identification of a given device 24 may indicate the user's place of work or residence, income level, cultural and recreational interests, etc. Data center 38 may receive and store this information together with the identifier of device 24 (such as its MAC address) for subsequent cross-referencing and follow-up.

In another embodiment, data center 38 may cross-reference the device identifiers extracted by sensors 22 with other, previously-stored demographic data. For example, for research purposes a group of people may be recruited to register their personal demographic information, together with the identifiers of their wireless communication devices 24. (It is not necessary that these people carry or use any special equipment.) When members of this group visit locations in which sensors 22 are deployed, the sensors record and report their presence to data center 38. The data center uses the known demographics of these people in characterizing the audience more generally.

FIG. 5 is a flow chart that schematically shows details of presence data extraction step 72, for extracting behavioral information from wireless communications, in accordance with an embodiment of the present invention. “Presence” in this context refers to physical and temporal details of the location of a given device 24 (and hence of the user of the device), over both short and longer terms. The presence data is generated by detecting and comparing transmissions by device 24 (as identified by the device identifier, such as the MAC address) that are received by one or more of transceivers 42. Although certain steps in this method are attributed in the description below to inquiry/discovery agent 48, they may alternatively be performed by a computer in data center 38.

Controller 46 extracts a measure of the signal strength from each received transmission from a given device 24, at a signal strength measurement step 110. For Bluetooth devices, for example, the signal strength may be derived simply by performing an Inquiry with RSSI. Alternatively, other methods for signal strength measurement may be used, as are known in the art. The signal strength (in decibels) is linearly related to the distance between transceiver 42 and device 24 (when working within the dynamic range of the receiver and assuming an ideal environment with no changing occlusions), with a constant of proportionality that can be determined by a calibration procedure.

Thus, agent 48 is able to use the signal strength measurement made at step 110 in estimating the distance of device 24 from transceiver 42, at a distance estimation step 112. Furthermore, if directional measurements are available (such as distance estimates from two or more different transceivers), agent. 48 may be able to estimate the location of device 24 by triangulation or trilateration. For advertising applications, the measured distance and location of device 24 give an indication of whether the user of the device is likely to have seen and noticed the advertisement in question.

Agent 48 checks memory 54 to determine whether the device 24 with which transceiver 42 communicated in step 110 was detected previously in the recent past by this sensor 22, at a past detection step 114. If so, agent 48 uses these past measurements in modeling the recent behavior of the user, at a velocity and dwell detection step 116. Thus, agent 48 may, for example, measure how long the user has spent in this location (dwell time), as well as the “dwell profile,” in terms of the distance and position of the user relative to the sensor.

If device 24 has moved significantly between successive measurements, agent 48 can compute the speed and direction (toward or away from sensor 22) of the user's movement. To find the location of individuals along a straight line (such as a street, a corridor or a mall avenue), agent 48 can use the estimated distance measured from a single antenna. Agent 48 may be able to automatically classify the directions of movement using clustering algorithms. In outdoor environments, the speed of movement can also be used to infer whether the user is on foot or in a vehicle. All of these factors affect the likelihood that the user has seen and noticed the advertisement.

Upon receiving a record of presence of a given device 24 from one of sensors 22, a computer in data center 38 may check whether this same device was previously detected by another sensor, at a previous detection step 118. Additionally or alternatively, processing unit 40 or data center 38 may detect repeated appearances of a given device at the same location, which may indicate either interest or habitual behavior by the user of the device. The data center may then compare the reports from one or more sensors of the appearances of a given device at different times in order to extract a pattern of motion of the user of the device and of the locations where the user has spent time, at a pattern extraction step 120. Additionally or alternatively, data center 38 may combine and compare the dwell and velocity information collected for multiple devices 24 to extract overall traffic patterns.

The patterns extracted at step 120 allow data center 38 to model the user's behavior and preferences, possibly in combination with the demographic information extracted at step 70. For example, the data center can measure the impact and effectiveness of an advertising campaign by using sensors 22 both on the advertising media and in the retail stores that appear in the advertising media (or sell the brand or product that is advertised). Data center 38 correlates between reports of people who were found near the advertising media and people who entered the store or a sub-section of the store, and uses the correlation to assess the effect of the advertisement on people who were exposed to it. Sensors may also be placed at the point of sale in order to evaluate people's tendency to make a purchase after being exposed to a certain advertisement. Effectiveness can be measured as a function of any measured exposure parameter, such as the frequency and/or accumulated time of exposure to the advertising content.

Additionally or alternatively, data center 38 may check for correlation of the locations of different device identifiers at different times, at a device correlation step 122. In other words, the data center may cross-reference reports from different sensors 22, as well as from external sources, such as data from cellular operators or points of sale, in order to create associations between co-occurring identifiers, i.e., device identifiers that were detected together at the same location or locations at multiple different times. This sort of co-occurrence may mean either that both device identifiers belong to the same person or that they belong to people who are frequently together. The device identifiers that are detected and associated with one another may include, for example, cellular network identifiers (TMSI, IMEI, IMSI); Bluetooth and WLAN MAC addresses; loyalty club cards used at the point of purchase; GPS navigation and social location-based service usernames; and video face recognition data.

Associated identifiers may indicate any of the following:
Multiple identifiers assigned to the same hardware, such as the WLAN MAC, Bluetooth MAC and IMEI of the same cell phone.
Identifiers belonging to different devices carried by the same person, such as the respective Bluetooth MAC addresses of a cell phone and an earpiece used by a single individual.
Identifiers belonging to devices carried by related people, such as the IMEIs of two cell phones carried by a married couple.
   By creating the appropriate association, data center 38 is able to normalize its records (i.e., avoid duplication and enhance overall tracking accuracy in reports of presence of the same person) and to enrich its store of demographic information regarding people whose devices are detected in system 20.

Following the analysis performed in steps 118-122, data center 38 records the behavioral information that it has collected and processed, at a result recording step 124, and proceeds to generate reports and/or further data analysis. The behavioral information collected in step 72 (FIG. 5) may be correlated with the demographic information from step 70 (FIG. 4) in order to enrich and segment the analysis.

Although the embodiments described above relate mainly to controlling and assessing the effectiveness of advertising in public spaces, the principles of the present invention may similarly be applied in a wide range of venues and applications. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for monitoring an audience, comprising:
receiving transmissions over the air from one or more wireless communication devices belonging to members of the audience at a location; and
analyzing the transmissions in order to derive a characteristic of the audience,
wherein the transmissions are selected from a group of transmission types consisting of:
transmissions in response to a signal transmitted over the air for initiating a connection with the wireless communication devices at the location, in accordance with a standard communication protocol; and
transmissions that are broadcast over the air, in accordance with a standard communication protocol, by the one or more wireless communication devices.

2. The method according to claim 1, wherein receiving the transmissions comprises receiving broadcast transmissions from the one or more wireless communication devices, and wherein analyzing the transmissions comprises analyzing the broadcast transmissions in order to derive the characteristic of the audience.

3. (canceled)

4. The method according to claim 1, wherein the signal and the responses are transmitted over an Industrial, Scientific and Medical (ISM) radio band.

5. The method according to claim 4, wherein the protocol is selected from a group of protocols consisting of Personal Area Network (PAN) and Wireless Local Area Network (WLAN) protocols.

6. The method according to claim 1, and comprising receiving cellular transmissions made over a cellular network by one or more mobile devices belonging to the members of the audience, and wherein analyzing the responses comprises analyzing the cellular transmissions in order to derive the characteristic of the audience.

7. The method according to claim 1, wherein analyzing the transmissions comprises counting a number of the wireless communication devices operating at the location.

8. The method according to claim 1, wherein receiving the transmissions comprises receiving multiple, successive transmissions from at least one of the wireless communication devices, and wherein analyzing the transmissions comprises estimating a dwell time of the at least one of the wireless communication devices in the location responsively to the multiple, successive transmissions.

9. The method according to claim 1, wherein analyzing the transmissions comprises estimating respective distances of the wireless communication devices from a receiver that receives the responses.

10. The method according to claim 9, wherein analyzing the transmissions comprises detecting motion of one or more of the members of the audience using multiple estimates of the respective distances over time.

11. The method according to claim 10, wherein detecting the motion comprises estimating a velocity of the motion based on the multiple estimates.

12. The method according to claim 1, wherein the transmissions are received at multiple different locations, and wherein analyzing the transmissions comprises detecting a presence of at least one of the wireless communication devices at two or more of the locations at different, respective times.

13. The method according to claim 12, wherein analyzing the transmissions comprises tracking a pattern of behavior of at least one of the members of the audience to whom the at least one of the wireless communication devices belongs responsively to the detected presence.

14. The method according to claim 1, wherein analyzing the transmissions comprises extracting identifiers of the wireless communication devices from the transmissions and cross-referencing the identifiers with other identifying information regarding the members of the audience.

15. The method according to claim 14, wherein cross-referencing the identifiers comprises creating an association between at least two co-occurring identifiers that were extracted from the transmissions.

16. The method according to claim 1, wherein analyzing the transmissions comprises extracting demographic information from the responses with regard to the members of the audience.

17. The method according to claim 16, wherein extracting the demographic information comprises processing the transmissions to discover identifiers of the wireless communication devices, and analyzing the identifiers to find the demographic information.

18. A method for monitoring an audience, comprising:
receiving signals that are transmitted over the air, in accordance with a standard communication protocol, by one or more wireless communication devices belonging to members of the audience;
processing the transmissions in order to discover identifiers of the wireless communication devices; and
analyzing the identifiers in order to extract demographic information with regard to the members of the audience.

19. The method according to claim 18, wherein analyzing the identifiers comprises processing device names or user names transmitted by the wireless communication devices in order to extract the demographic information.

20. The method according to claim 18, wherein the demographic information comprises at least one item of data with respect to a member of the audience, selected from a group of items consisting of a name, an age, a gender, and an ethnic group of the member.

21. Apparatus for monitoring an audience, comprising:
a transceiver, which is configured to be deployed at a location and to receive transmissions over the air from one or more wireless communication devices belonging to members of the audience at the location,
wherein the transmissions are selected from a group of transmission types consisting of:
transmissions in response to a signal transmitted over the air for initiating a connection with the wireless communication devices at the location, in accordance with a standard communication protocol; and
transmissions that are broadcast over the air, in accordance with a standard communication protocol, by the one or more wireless communication devices; and
a processing unit, which is configured to analyze the transmissions in order to derive data indicative of a characteristic of the audience.

22-40. (canceled)

41. The method according to claim 1, wherein receiving the transmission comprises initiating the connection with the wireless communication devices in accordance with the standard communication protocol, by transmitting the signal over the air at the location, and receiving the transmissions in response to the signal over the air from the one or more wireless communication devices.
